(19) United States
(12) Patent Application Publication
(10) Pub. No.: US 2007/0245861 A1
(43) Pub. Date: Oct. 25, 2007

(54) Pipe wrench stand

(76) Inventor: Robert W. Shields, Dimondale, MI (US)

Correspondence Address: LITMAN LAW OFFICES, LTD., P.O. BOX 15035, CRYSTAL CITY STATION, ARLINGTON, VA, 22215, US

(21) Appl. No.: 11/727,341

(22) Filed: Mar. 26, 2007

Related U.S. Application Data
(60) Provisional application No. 60/793,658, filed on Apr. 21, 2006.

(51) Int. Cl. B25B 13/58; B25B 13/16

(52) U.S. Cl. 81/180.1; 81/165

(57) ABSTRACT

A pipe wrench having a movable arm mounted thereon. The arm is pivotally attached to the back of the wrench and may be foldable for storage or pivoted to an in-use, support-stand position to allow the wrench to be self-supporting when desired.

### CROSS-REFERENCE TO RELATED APPLICATION

This application claims the benefit of U.S. Provisional Patent Application Ser. No. 60/793,658, filed Apr. 21, 2006.

### BACKGROUND OF THE INVENTION

1. Field of the Invention

The present invention generally relates to hand tools. More specifically, the present invention is drawn to a pipe wrench having a pivoting support stand.

2. Description of the Related Art

The pipe wrench is probably the most frequently used tool in the plumbing art. In many instances, the plumbing job requires the use of two pipe wrenches wherein one of the wrenches is utilized as a vise and the second wrench is used to tighten or loosen the particular pipefitting. Employing two wrenches in this manner is somewhat difficult and hazardous in that the first wrench is held in one hand to prevent rotation while the second wrench must be pushed or pulled with the other hand to cause rotation. In this scenario, slippage of one of the wrenches often results in injuries such as sprained wrists, broken hands and/or scraped skin. A device or arrangement that would alleviate this situation would certainly be a welcome addition in the plumbing art. Thus, a pipe wrench stand solving the aforementioned problems is desired.

The related art discloses many stands utilized to support pipe wrenches. Pertinent samples of such related art are identified and cited in the accompanying IDS. However, none of the cited and identified related art discloses a pipe wrench stand as will subsequently be described and claimed in the instant invention.

### SUMMARY OF THE INVENTION

The present invention is a pipe wrench having a movable arm mounted thereon. The arm is pivotally attached to the back of the wrench and may be foldable or pivoted to an in-use, support-stand position when desired.

Accordingly, the invention presents a pipe wrench having an effective built-in arm that allows the wrench to be self-supporting when utilized as a vise or the like. The invention provides for improved elements thereof in an arrangement for the purposes described that are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective view of a pipe wrench stand according to the present invention.

FIG. 2 is a perspective view of a pipe wrench stand with the wrench jaws in a downward position according to the present invention.

FIG. 3 is a perspective view of a pipe wrench stand with the stand in folded position according to the present invention.

Similar reference characters denote corresponding features consistently throughout the attached drawings.

### DETAILED DESCRIPTION OF THE PREFERRED EMBODIMENT

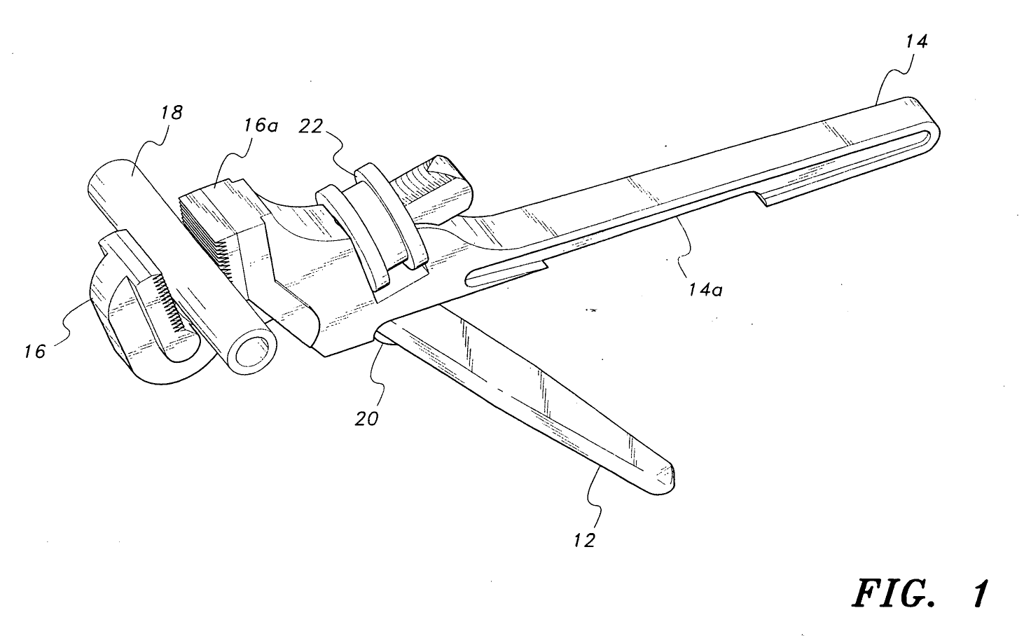

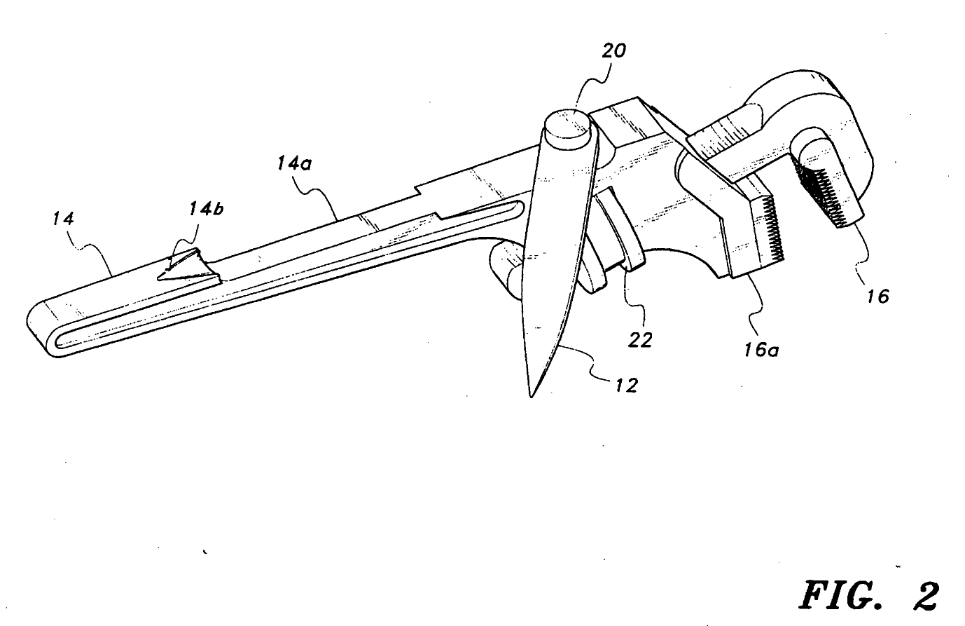

Attention is first directed to FIGS. 1 and 2 wherein the pipe wrench stand of the present invention is shown in an in-use position. The stand comprises an elongate arm 12 mounted on the rear surface of the handle 14 of a pipe wrench. The pipe wrench is provided with a head portion having conventional adjustable and stationery jaws 16, 16a for gripping a work piece such a pipe 18. Elongate arm 12 is mounted for pivoting movement on the rear surface of handle 14. A pivot pin 20 functions to provide the attachment means for mounting the arm to the handle. Pin 20 provides a permanent attachment in that the arm cannot be removed from the handle under normal use conditions. The pivot point defined by pin 20 is adjacent the adjustment knurl 22 located on the front surface of handle 14. When pivoted to positions as shown in the above-cited Figs., arm 12 provides means that permits the wrench to stand in an upright position on a planar surface and function as a vice or the like. The arm must have an adequate length to provide adequate support and to allow a user to use a foot for further support. It has been determined that the arm should be at least half the length of the wrench handle.

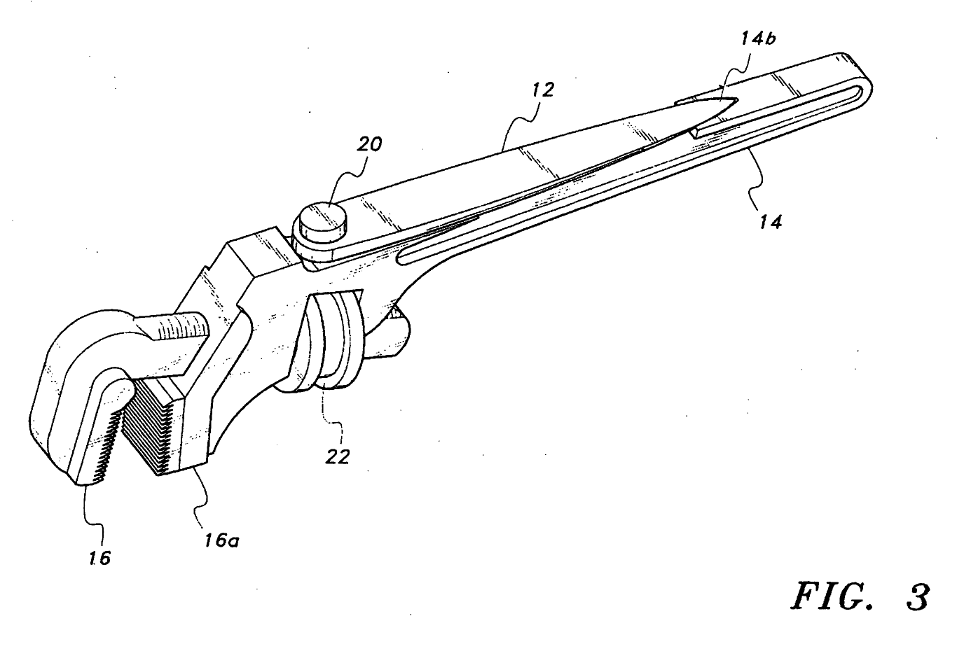

As best seen in FIG. 3, arm 12 is pivoted to a non-use position wherein its length is coaxial with the length of the handle. A niche 14a is formed in the handle for receiving the arm. Niche 14a has a length that is substantially coextensive with the length of arm 12. A notch 14b is provided to receive the free end of the arm so that the arm can be secured in the non-use position.

It is to be understood that the present invention is not limited to the embodiment described above, but encompasses any and all embodiments within the scope of the following claims.

I claim:

1. A pipe wrench and stand therefore, comprising:
a wrench, said wrench having a head portion;
a handle extending from said head portion, said handle having length and a rear surface; and
an elongate arm pivotally mounted on said rear surface of said handle, said elongate arm having a length that is at least half the length of said handle.

2. The pipe wrench and stand therefore according to claim 1, further including a niche disposed in said rear surface of said handle, said niche having a length that is coextensive with the length of said elongate arm, whereby said elongate arm is received in said niche.

3. The pipe wrench and stand therefore according to claim 1, wherein said elongate arm has a first end and a second end and wherein said first end is pivotally attached to said handle closely adjacent said head portion.

4. The pipe wrench and stand therefore according to claim 3, wherein said second end of elongate arm is a free end.

5. A pipe wrench and stand therefore, comprising:
a wrench, said wrench having a head portion;
a handle extending from said head portion, said handle having length and a rear surface; and
an elongate arm, said elongate arm having a first end pivotally mounted on said rear surface of said handle adjacent said head portion, said elongate arm having a length that is at least half the length of said handle.

6. The pipe wrench and stand therefore according to claim 5, further including a niche disposed in said rear surface of said handle, said niche having a length that is coextensive with the length of said elongate arm, whereby said elongate arm is received in said niche.

7. The pipe wrench and stand therefore according to claim 5, wherein said elongate arm has a second end and wherein said second end is a free end.

8. The pipe wrench and stand therefore according to claim 7, further including a notch disposed on said rear surface of said handle, whereby said second end of said elongate arm is received in said notch.

9. A pipe wrench and stand therefore, comprising:
a wrench, said wrench having a head portion;
a handle extending from said head portion, said handle having length and a rear surface;
an elongate arm, said elongate arm having a first end pivotally mounted on said rear surface of said handle adjacent said head portion and a second free end, said elongate arm having a length that is at least half the length of said handle; and
a niche disposed in said rear surface of said handle, said niche having a length that is coextensive with the length of said elongate arm, whereby said elongate arm is received in said niche.

10. The pipe wrench and stand therefore according to claim 9, further including a notch disposed on said rear surface of said handle, whereby said second end of said elongate arm is received in said notch.
